(19) United States
(12) Patent Application Publication
(10) Pub. No.: US 2025/0238039 A1
(43) Pub. Date: Jul. 24, 2025

(54) METHOD AND SYSTEM FOR TRAJECTORY TRACKING CONTROL OF VEHICLE-MANIPULATOR COUPLING SYSTEM WITH FINITE TIME PRESCRIBED PERFORMANCE

(71) Applicant: HUAZHONG UNIVERSITY OF SCIENCE AND TECHNOLOGY, Hubei (CN)

(72) Inventors: Xianbo Xiang, Hubei (CN); Xinyang Xiong, Hubei (CN); Shaolong Yang, Hubei (CN); Gong Xiang, Hubei (CN); Guohua Xu, Hubei (CN)

(73) Assignee: HUAZHONG UNIVERSITY OF SCIENCE AND TECHNOLOGY, Hubei (CN)

(21) Appl. No.: 19/172,665

(22) Filed: Apr. 8, 2025

Related U.S. Application Data
(63) Continuation-in-part of application No. 18/610,243, filed on Mar. 19, 2024, now abandoned.

(30) Foreign Application Priority Data
Jul. 14, 2023 (CN) 202310870676.5

(51) Int. Cl. G05D 1/689; B25J 9/16; B63G 8/00; G05D 1/46; G05D 109/30

(52) U.S. Cl. CPC G05D 1/6895; B25J 9/1653; B25J 9/1664; B63G 8/001; G05D 1/46; B63G 2008/002; G05D 2109/38

(57) ABSTRACT

The disclosure provides a method and system for trajectory tracking control of a vehicle-manipulator coupling system with finite time prescribed performance. Specifically, a coupling weaken trajectory planning method is designed to reduce the system's coupling effects. A finite time performance function is designed to constrain the trajectory tracking error. In a case the constraint conditions corresponding to the finite time performance function are satisfied, the trajectory tracking error is converted to obtain a transformed error. The sliding mode surface is designed based on the transformed error to control the transformed error to converge in a finite time, and the external disturbance of the vehicle-manipulator coupling system is observed based on non-linear disturbance observer. The control input of the vehicle-manipulator coupling system is designed based on the sliding mode surface and the non-linear disturbance observer output. This ensures that the vehicle-manipulator coupling system can operate precisely along the desired trajectory.

### CROSS-REFERENCE TO RELATED APPLICATION

This is a continuation-in-part application of U.S. application Ser. No. 18/610,243, filed on Mar. 19, 2024, which claims the priority benefit of China application serial no. 202310870676.5, filed on Jul. 14, 2023. The entirety of the above-mentioned patent application is hereby incorporated by reference herein and made a part of this specification.

### BACKGROUND

### Technical Field

The disclosure belongs to the technical field of underwater operations of unmanned

vehicles, and particularly relates to a method and system for trajectory tracking control of a vehicle-manipulator coupling system with finite time prescribed performance.

### Description of Related Art

Currently, with the growing demand for marine resource development, advanced underwater operation technology is playing an increasingly important role. Underwater vehicle-manipulator system has been widely used in various marine operation scenarios, such as seabed mineral mining, mariculture, deep-sea oil and gas system operation and maintenance, and underwater rescue. As the operation scenarios become increasingly complex, the requirements for precision, stability, and transient-state performance of control of the underwater vehicle-manipulator system are gradually increasing. However, in practical applications, the motion of the underwater vehicle-manipulator system is affected by unknown fluid disturbances, non-linear system model uncertainty, and complex dynamic coupling effects between the underwater vehicle and the manipulator, which brings great challenges to the stable operation of the underwater vehicle-manipulator system. In addition, the underwater vehicle-manipulator system usually needs to operate near the bottom. If large oscillations occur during the control process, it is likely to cause safety hazards. Therefore, in order to improve operating efficiency and safety, advanced control algorithms need to be researched to satisfy the precision, robustness, and transient-state performance constraints of the controller.

### SUMMARY

In view of the shortcomings of the related art, the purpose of the disclosure is to provide a method and system for trajectory tracking control of a vehicle-manipulator coupling system with finite time prescribed performance and a weakly coupling trajectory, aiming to solve the problem that the trajectory tracking control of the underwater vehicle-manipulator system is affected by model uncertainty, dynamic coupling effects, and external disturbances.

In order to achieve the above purpose, in the first aspect, the disclosure provides a method for trajectory tracking finite time prescribed performance control of a vehicle-manipulator coupling system. The method is applied to the vehicle-manipulator coupling system to control the motion trajectory of the system. The vehicle-manipulator coupling system includes an underwater vehicle and a robotic arm, and the method includes the following.

A present motion state and a desired trajectory of the vehicle-manipulator coupling system are obtained, so as to calculate a difference between the present motion state and the desired trajectory to obtain a trajectory tracking error. The present motion state of the underwater vehicle can be obtained by an onboard attitude sensor, such as the inertial measurement unit (IMU). The present motion state of the joint of the robotic arm can be obtained by a motor encoder. The present motion state of an end effector of the robotic arm can be obtained by the forward kinematic model of the vehicle-manipulator coupling system. The desired trajectory can be obtained by a coupling weaken trajectory planning method.

An improved finite time performance function is designed to constrain the trajectory tracking error so that the vehicle-manipulator coupling system reaches a steady state when the trajectory tracking error converges to a preset convergence boundary. Also, when an operation time of the vehicle-manipulator coupling system exceeds a preset convergence time, a gradient of the finite time performance function is not zero, so as to avoid generating a singularity in a calculation of the state of the vehicle-manipulator coupling system and to ensure that a controller of the vehicle-manipulator coupling system does not diverge.

In a case that constraint conditions corresponding to the finite time performance function are satisfied, the trajectory tracking error is converted to obtain a corresponding transformed error.

A sliding mode surface of the vehicle-manipulator coupling system is designed based on the transformed error to control the transformed error to converge in a finite time, and an external disturbance of the vehicle-manipulator coupling system is observed based on a non-linear disturbance observer with the sliding mode surface.

A control input of the vehicle-manipulator coupling system is designed based on the sliding mode surface and the external disturbance observed, so that the vehicle-manipulator coupling system is controlled to operate according to the desired trajectory.

In an optional example, the finite time performance function is:

$${ρ}_{m} ( t ) = \{ \begin{matrix}{( {{ρ}_{0}}^{α} - αβ t )}^{1 / α} + {ρ}_{c} , & 0 \leq t < {T}_{m} \\ ( {ρ}_{c} - {ρ}_{∞} ) {e}^{- k ( t - {T}_{m} )} + {ρ}_{∞} , & t \geq {T}_{m}\end{matrix}$$

In the formula, ρₘ(t) represents a trajectory tracking error boundary; ρ₀ represents a preset initial error boundary, and ρ₀>0; ρ_{c} represents a trajectory tracking error preset convergence boundary, and 0<ρ_{c}<<ρ₀; ρ_{∞} represents a trajectory tracking error asymptotic convergence boundary, and 0<ρ_{∞}<ρ_{c}; α, β, k represent preset performance parameters, configured to adjust a convergence rate and a convergence time of the finite time performance function; e represents a natural constant; t represents a time process; and Tₘ represents a preset convergence time, and Tₘ=ρ₀^{α}/(αβ).

In an optional example, ηₑ represents the trajectory tracking error, ηₑ=η−η_{d}, η represents a system motion state, and η_{d} represents a system desired trajectory. The desired trajectory is obtained by a proposed coupling weaken trajectory planning method.

The finite time performance function constraining the trajectory tracking error is, specifically:

$$- {κ}_{l} {ρ}_{m} ( t ) < {η}_{e} < {κ}_{u} {ρ}_{m} ( t )$$

In the formula, κₗ and κᵤ represent performance boundary coefficients, which can be designed during a control test process to meet the desired control performance.

In an optional example, in order to satisfy constraining the finite time performance function, error transformation is performed on the trajectory tracking error ηₑ. A transformed error is represented by ηₑ, and:

$${η}_{ε} = \frac{1}{2} ln \frac{ς + {k}_{l}}{{k}_{u} - ς}$$

In the formula, [symbol] =ηₑ/ρₘ; the first order derivative \dot{η}_{ε} of the transformed error η_{ε} is:

$${\dot{η}}_{ε} = γ ( {\dot{η}}_{e} - \frac{{η}_{ε} {\dot{ρ}}_{m}}{{ρ}_{m}} ) ;$$

\dot{η}ₑ is the first order derivative of ηₑ, ρₘ is the abbreviation of ρₘ(t), and \dot{ρ}ₘ is the abbreviation of \dot{ρ}ₘ(t), which is the first order derivative of ρₘ(t).

In an optional example, the dynamic model of the vehicle-manipulator coupling system is represented by:

$$\{ \begin{matrix}{\dot{x}}_{1} = {x}_{2} \\ {\dot{x}}_{2} = {A}_{m} {τ}_{m} + {B}_{m} + {F}_{dm}\end{matrix}$$

In the formula, x₁=η, x₂ represents a system speed state vector, Aₘ and Bₘ represent a matrix related to a dynamics model of the system, F_{dm} represents the external disturbance unknown received by the system, and τₘ represents a control input of the system.

The sliding mode surface Sₘ is designed based on the transformed error η_{ε}:

$${S}_{m} = {λ}_{m} {η}_{ε} + {\dot{η}}_{ε}$$

In the formula, λₘ represents a diagonal sliding mode surface coefficient matrix, which can be designed by the engineers.

In an optional example, observing the external disturbance of the vehicle-manipulator coupling system based on the non-linear disturbance observer and the sliding mode surface is specifically:

$$\{ \begin{matrix}{\hat{F}}_{dm} = {α}_{dm} + {K}_{dm} {S}_{m} \\ {\dot{α}}_{dm} = - {L}_{dm} {α}_{dm} - {L}_{dm} ( {K}_{dm} {S}_{m} + {γ}^{- 1} {H}_{m} + {A}_{m} {τ}_{m} + {B}_{m} )\end{matrix}$$

In the formula, \hat{F}_{dm} represents the observation of the unknown external disturbance, α_{dm} represents an auxiliary intermediate variable of the non-linear disturbance observer, L_{dm} and K_{dm} represent gain coefficients of the non-linear disturbance observer, K_{dm} satisfies K_{dm}=L_{dm}γ⁻¹;

$${H}_{m} = ( {λ}_{m} γ + \dot{γ} ) ( {\dot{η}}_{e} - \frac{{η}_{e} {\dot{ρ}}_{m}}{{ρ}_{m}} ) - γ \cdot \frac{{\dot{η}}_{e} {\dot{ρ}}_{m} {ρ}_{m} + {η}_{e} {\ddot{ρ}}_{m} {ρ}_{m} - {η}_{e} {{\dot{ρ}}_{m}}^{2}}{{{ρ}_{m}}^{2}} - γ {\ddot{η}}_{d} ,$$

\dot{γ} represents the first order derivative of γ; \ddot{ρ}ₘ is an abbreviation of \ddot{ρ}ₘ(t), which is the second order derivative of ρₘ(t); and \ddot{η}_{d} represents the second order derivative of the desired trajectory η_{d}.

In an optional example, designing the control input of the vehicle-manipulator coupling system based on the sliding mode surface and the external disturbance observed is specifically:

$${τ}_{m} = {A}_{m}^{- 1} [ - {B}_{m} - {\hat{F}}_{dm} - {γ}^{- 1} ( {H}_{m} + {k}_{α} {‖ {s}_{m} ‖}^{\frac{1}{2}} sign ( {s}_{m} ) + {\int }_{0}^{t} {k}_{γ} sign ( {s}_{m} ( τ ) ) d τ ) ]$$

In the formula, k_{α} and k_{γ} represent controller parameters to be designed, sign(·) represents a signum function, τ represents the time, sₘ(t) represents a value of sₘ at the time τ, and ∫₀^{t}k_{γ}sign(sₘ(τ))dτ represents an integral of k_{γ}sign(sₘ) at a time interval [0, t].

The disclosure provides a coupling weaken trajectory planning method for reducing the dynamic coupling effect of the vehicle-manipulator coupling system. Firstly, the dynamic equation of the vehicle-manipulator coupling system can be written as follows:

$${M}_{v} \dot{v} + {C}_{v} ( v ) v + {D}_{v} ( v ) v + {G}_{v} ( {η}_{v 2} ) - {M}_{mv , q} ( q ) \ddot{q} - {M}_{mv , v} ( q ) \dot{v} - {C}_{mv} ( q , \dot{q} , v ) - {D}_{mv} ( q , \dot{q} , v ) - {G}_{mv} ( q , {η}_{v 2} ) = 0.$$

Where Mᵥ includes a rigid body inertia matrix and an added mass inertia matrix of the underwater vehicle, Cᵥ(v) includes a vehicle coriolis centripetal force matrix of rigid body and a coriolis centripetal force matrix of added mass, Dᵥ(v) denotes a damping matrix of the underwater vehicle, Gᵥ(ηᵥ₂) denotes a gravity and a buoyancy of the underwater vehicle, M_{mv,q}(q) denotes a coupling inertial matrix induced by an acceleration of the robotic arm, Cₘᵥ(q, \dot{q}, v) denotes a coupling coriolis centripetal force and a moment acting on the underwater vehicle induced by the coupling velocity of the robotic arm and the underwater vehicle, Dₘᵥ(q, \dot{q}, v) denotes a coupling damping force and a moment acting on the vehicle induced by the coupling velocity of the robotic arm and the underwater vehicle, Gₘᵥ(q, ηᵥ₂) denotes a coupling buoyancy and a gravity force and a moment of the robotic arm acting on the underwater vehicle. The parameters of the above matrices can be obtained by an empirical formula of the hydrodynamics or the towing test. v denotes a velocity vector of the underwater vehicle, ηᵥ₂ denotes an attitude vector of the underwater vehicle. Both of them can be obtained by the onboard attitude sensor, such as the IMU. \dot{v} denotes an acceleration vector of the underwater vehicle, which can be obtained by a velocity differentiation process. q denotes a joint angle vector of the robotic arm, \dot{q} denotes a joint angular velocity vector of the robotic arm, \ddot{q} denotes a joint angular acceleration vector of the robotic arm. The above three parameters can be obtained by the motor encoder of each joint.

The dynamic equation of the vehicle-manipulator coupling system can be transformed into:

$$[ {M}_{v} - {M}_{mv , v} ( q ) ] \dot{v} = [ ( {C}_{mv} ( q , \dot{q} , v ) + {D}_{mv} ( q , \dot{q} , v ) + {G}_{mv} ( q , {η}_{v 2} ) - {C}_{v} ( v ) v - {D}_{v} ( v ) v - {G}_{v} ( {η}_{v 2} ) ) {\ddot{q}}^{†} + {M}_{mv , q} ( q ) ] \ddot{q} .$$

Where \ddot{q}^{†} denotes a normalized inverse vector of the joint angular acceleration, which is designed as:

$${\ddot{q}}^{†} = [ \frac{{\ddot{q}}_{1}}{{‖ \ddot{q} ‖}^{2}} , \frac{{\ddot{q}}_{2}}{{‖ \ddot{q} ‖}^{2}} , ⋯ , \frac{{\ddot{q}}_{n}}{{‖ \ddot{q} ‖}^{2}} ] .$$

Where n denotes the number of the joints of the robotic arm, \ddot{q}; (with i=1,2, . . . , n) denotes the i^{th} joint acceleration of the robotic arm. Then the following equation can be obtained:

\dot{v}=V_{coupling}_{ₘᵥ}\ddot{q}

Where V_{coupling}_{ₘᵥ} is designed as a coupling characteristic index, which can be written as:

$${V}_{coupling} = {{V}_{cv}}^{- 1} {V}_{cm} .$$

$$Where :$$

$${V}_{cv} = {M}_{v} - {M}_{mv , v} ( q ) . {V}_{cm} = [ {C}_{mv} ( q , \dot{q} , v ) + {D}_{mv} ( q , \dot{q} , v ) + {G}_{mv} ( q , {η}_{v 2} ) - {C}_{v} ( v ) v - {D}_{v} ( v ) v - {G}_{v} ( {η}_{v 2} ) ] {\ddot{q}}^{†} + {M}_{mv , q} ( q )$$

The provided coupling characteristic index V_{coupling}_{ₘᵥ} reveals the motion coupling relationship between the robotic arm and the underwater vehicle. In order to quantify the coupling effects of the vehicle-manipulator coupling system, a singular value decomposition of V_{coupling}_{ₘᵥ} is conducted, and a weighted average for each singular value can be obtained as S_{coupling}, which is related to the system trajectory characteristic v, \dot{v}, ηᵥ₂, q, \dot{q}, \ddot{q}. Then it can be written as S_{coupling}(v, \dot{v}, ηᵥ₂, q, \dot{q}, \ddot{q}), and technicians can know that the smaller S_{coupling}(v, \dot{v}, ηᵥ₂, q, \dot{q}, \ddot{q}), a weakly coupling characteristic can be got. The coupling characteristic index V_{coupling}_{ₘᵥ} can be processed by a singular value decomposition, and a coupling intensity of the vehicle-manipulator coupling system can be quantitatively presented by

$${S}_{coupling} = ( v , \dot{v} , {η}_{v 2} , q , \dot{q} , \ddot{q} ) = \frac{{s}_{1} {ω}_{1} + {s}_{2} {ω}_{2} + ⋯ + {s}_{m} {ω}_{m}}{m} ,$$

where ωᵢ denotes the ith singular value of V_{coupling}_{ₘᵥ}, sᵢ denotes the weight coefficients to be designed, i=1,2, . . . , m, m denotes the number of the singular values of V_{coupling}_{ₘᵥ}

Then, the coupling weaken trajectory planning method can be designed as:

$$min J ( v , \dot{v} , {η}_{v 1} , {η}_{v 2} , q , \dot{q} , \ddot{q} ) = {κ}_{1} {S}_{coupling} ( v , \dot{v} , {η}_{v 2} , q , \dot{q} , \ddot{q} ) + {κ}_{2} {D}_{target} ( {η}_{v 1} , {η}_{v 2} , q ) .$$

Where J(v, \dot{v}, ηᵥ₂, q, \dot{q}, \ddot{q}) denotes an optimization function with respect to the desired trajectory v, \dot{v}, ηᵥ₁, ηᵥ₂, q, \dot{q}, \ddot{q}, ηᵥ₁ denotes a position vector of the underwater vehicle, which can be obtained by a camera system. D_{target}(ηᵥ₁,ηᵥ₂,q) denotes a distance between an end effector of the robotic arm and the target, which can be obtained by the camera system. The coupling weaken trajectory planning method is to find the minimum value of J(v, \dot{v}, ηᵥ₂, q, \dot{q}, \ddot{q}) , then the desired trajectory with weakly coupling characteristic can be obtained.

In the second aspect, the disclosure provides a system for trajectory tracking control of a vehicle-manipulator coupling system with finite time prescribed performance. The control system is used to control the motion trajectory of the vehicle-manipulator coupling system. The vehicle-manipulator coupling system includes an underwater vehicle and a robotic arm, and the control system includes as follows.

A parameter obtain unit is configured to obtain a present motion state and a desired trajectory of the vehicle-manipulator coupling system, so as to calculate a difference between the present motion state and the desired trajectory to obtain a trajectory tracking error.

A performance function design unit is configured to design a finite time performance function to constrain the trajectory tracking error so that the vehicle-manipulator coupling system reaches a steady state when the trajectory tracking error converges to a preset convergence boundary. Also, when an operation time of the vehicle-manipulator coupling system exceeds a preset convergence time, a gradient of the finite time performance function is not zero, so as to avoid generating a singularity in a calculation of the state of the vehicle-manipulator coupling system and to ensure that a controller of the vehicle-manipulator coupling system does not diverge.

In a case that constraint conditions corresponding to the finite time performance function are satisfied, an error transformation unit is configured to convert the trajectory tracking error to obtain a corresponding transformed error.

A control input design unit is configured to design a sliding mode surface of the vehicle-manipulator coupling system based on the transformed error to control the transformed error to converge in a finite time, and an external disturbance of the vehicle-manipulator coupling system is observed based on a non-linear disturbance observer and the sliding mode surface. A control input of the vehicle-manipulator coupling system is designed based on the sliding mode surface and the external disturbance observed, so that the vehicle-manipulator coupling system is controlled to operate according to the desired trajectory.

In an optional example, the finite time performance function designed by the performance function design unit is:

$${ρ}_{m} ( t ) = \{ \begin{matrix}{( {{ρ}_{0}}^{α} - αβ t )}^{1 / α} + {ρ}_{c} , & 0 \leq t < {T}_{m} \\ ( {ρ}_{c} - {ρ}_{∞} ) {e}^{- k ( t - {T}_{m} )} + {ρ}_{∞} , & t \geq {T}_{m}\end{matrix}$$

In the formula, ρₘ(t) represents a trajectory tracking error boundary; ρ₀ represents a preset initial error boundary, and ρ₀>0; ρ_{c} represents a trajectory tracking error preset convergence boundary, and 0<ρ_{c}<<ρ₀; ρ_{∞} represents a trajectory tracking error asymptotic convergence boundary, and 0<ρ_{∞}<ρ_{c}; α, β, k represent preset performance parameters, configured to adjust a convergence rate and a convergence time of the finite time performance function; e represents a natural constant; t represents a time process; and Tₘ represents a preset convergence time, and Tₘ=ρ₀^{α}/(αβ).

In an optional example, the trajectory tracking error obtained by the parameter obtain unit is represented as ηₑ, ηₑ=η−η_{d}, η represents the present motion state, and η_{d} represents the desired trajectory.

The finite time performance function designed by the performance function design unit constraining the trajectory tracking error is specifically: −kₗρₘ(t)<ηₑ<kᵤρₘ(t); in which kₗ and kᵤ represent performance boundary coefficients.

The error transformation unit performs error transformation on the trajectory tracking error ηₑ, a converted error resulted is represented by η_{ε}, and:

$${η}_{ε} = \frac{1}{2} ln \frac{ς + {k}_{l}}{{k}_{u} - ς}$$

In the formula, [symbol] =ηₑ/ρₘ; the first order derivative \dot{η}_{ε} of the transformed error η_{ε} is:

$${\dot{η}}_{ε} = γ ( {\dot{η}}_{e} - \frac{{η}_{ε} {\dot{ρ}}_{m}}{{ρ}_{m}} ) ;$$

\dot{η}ₑ is the first order derivative of ηₑ, ρₘ is the abbreviation of ρₘ(t), and \dot{ρ}ₘ is the abbreviation of \dot{ρ}ₘ(t), which is the first order derivative of ρₘ(t).

In the third aspect, the disclosure provides an electronic device, including at least one storage device for storing programs and at least one processor for executing the programs stored in the storage device, in which when the program stored in the storage device is executed, the processor is used to execute the method according to the first aspect or any possible example of the first aspect.

In the fourth aspect, the disclosure provides a computer-readable storage medium. The computer-readable storage medium stores a computer program, in which when the computer program is run on the processor, the processor executes the method according to the first aspect or any possible example of the first aspect.

In the fifth aspect, the disclosure provides a computer program product, in which when the computer program product is run on a processor, the processor executes the method according to the first aspect or any possible example of the first aspect.

Generally speaking, compared with the related art, the above technical solution conceived by the disclosure has the following beneficial effects.

The disclosure provides a method and a system for trajectory tracking control of a vehicle-manipulator coupling system with finite time prescribed performance, and an improved finite time performance function is proposed. Compared with the existing finite time performance function, the improved performance function disclosed in the disclosure does not lose the gradient when the vehicle-manipulator coupling system enters the steady state, and can better avoid generating singularities in the vehicle-manipulator coupling system, thereby the robustness is improved. In addition, the performance function can effectively ensure transient-state and steady-state error performance, and the convergence time can be preset. Afterward, the disclosure observes the external disturbance based on a non-linear disturbance observer, and performs input control based on an improved finite time prescribed performance super-twisting sliding mode controller, which can effectively solve the problem of trajectory tracking control under external unknown disturbance, and can weaken the buffeting of the control system, thereby the control precision and robustness is improved.

### BRIEF DESCRIPTION OF THE DRAWINGS

FIG. 1 is a flow chart of a method for trajectory tracking control of a vehicle-manipulator coupling system with finite time prescribed performance according to an embodiment of the disclosure.

FIG. 2 is a schematic diagram of an underwater vehicle-manipulator system according to an embodiment of the disclosure.

FIG. 3 is a block diagram of the finite time prescribed performance control according to an embodiment of the disclosure.

FIG. 4 is a curve diagram of a trajectory tracking performance of the underwater robotic arm system according to an embodiment of the disclosure.

FIG. 5 is a curve diagram of a trajectory tracking error of the underwater robotic arm system according to an embodiment of the disclosure.

FIG. 6 is a curve diagram of a control input of the underwater robotic arm system according to an embodiment of the disclosure.

FIG. 7 is a curve diagram of an observation performance of a non-linear disturbance observer according to an embodiment of the disclosure.

FIG. 8 is a curve diagram of an observation error of the non-linear disturbance observer according to an embodiment of the disclosure.

FIG. 9 is a curve diagram of a dynamic coupling disturbance received by the underwater vehicle according to an embodiment of the disclosure.

FIG. 10 is a curve diagram of errors in the position tracking from dynamic positioning of the underwater vehicle according to an embodiment of the disclosure.

FIG. 11 is a curve diagram of errors in the attitude tracking from dynamic positioning of the underwater vehicle according to an embodiment of the disclosure.

FIG. 12 is a diagram of an architecture of a system for controlling the finite time prescribed performance of trajectory tracking of the vehicle-manipulator coupling system according to an embodiment of the disclosure.

FIG. 13 is a schematic diagram illustrating the underwater oil and gas production system operation and maintenance tasks based on the vehicle-manipulator coupling system according to embodiments.

FIG. 14 is a schematic diagram of the embodiment of the vehicle-manipulator coupling system for wheel-type valve operation testing according to the embodiments.

### DESCRIPTION OF THE EMBODIMENTS

In order to make the purpose, technical solutions, and advantages of the disclosure more comprehensible, the disclosure will be further described in detail below with reference to the accompanying drawings and embodiments. It should be understood that the specific embodiments described here are merely used to explain the disclosure and the embodiments are not used to limit the disclosure.

The purpose of this disclosure is to, under the uncertainty, complex coupling disturbance, and unknown external disturbance of the model of the vehicle-manipulator coupling system, a control method is designed to realize the trajectory tracking control of the underwater vehicle-manipulator system, the trajectory tracking error should satisfy the preset transient-state and steady-state performance constraints, and the convergence time may be preset. In addition, the control method should have the ability to handle unknown external disturbances and weaken control buffeting to ensure the robustness and control precision of the vehicle-manipulator coupling system.

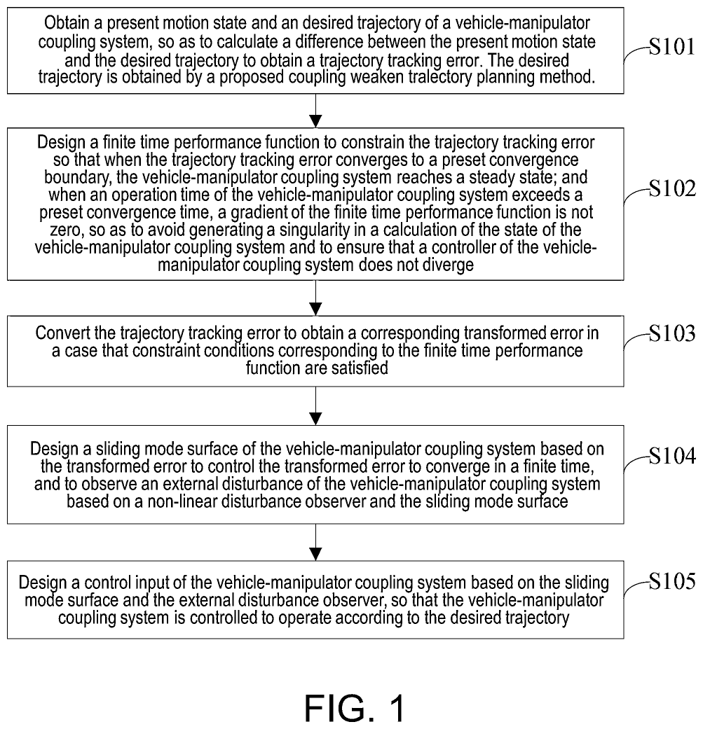

FIG. 1 is a flow chart of the trajectory tracking control of a vehicle-manipulator coupling system with finite time prescribed performance according to an embodiment of the disclosure. As shown in FIG. 1, the following steps are included.

S101. A present motion state and an desired trajectory of a vehicle-manipulator coupling system are obtained, so as to calculate a difference between the present motion state and the desired trajectory to obtain a trajectory tracking error. The desired trajectory is obtained by a proposed coupling weaken trajectory planning method.

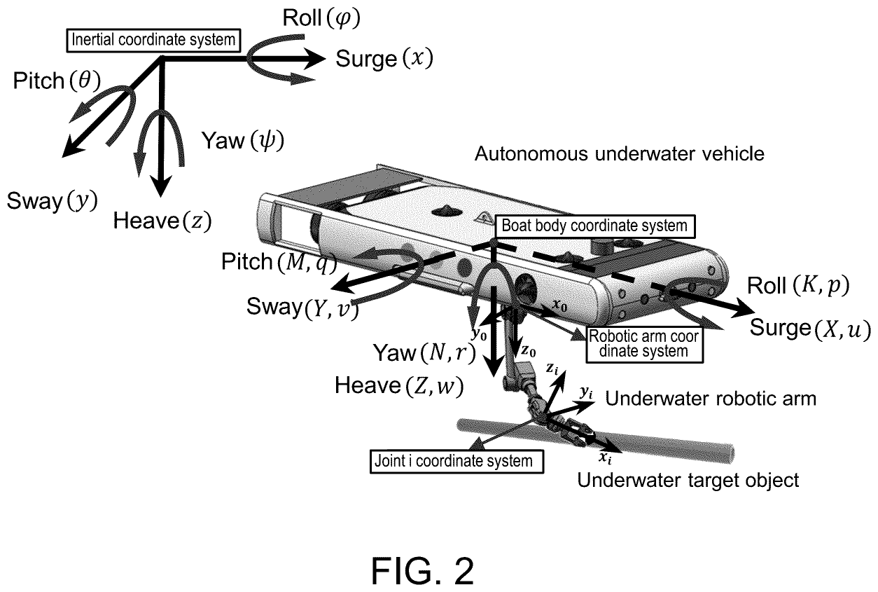

A structure of an underwater vehicle-manipulator coupling system is shown in FIG. 2.

S102. A finite time performance function is designed to constrain the trajectory tracking error so that when the trajectory tracking error converges to a preset convergence boundary, the vehicle-manipulator coupling system reaches a steady state; and when an operation time of the vehicle-manipulator coupling system exceeds a preset convergence time, a gradient of the finite time performance function is not zero, so as to avoid generating a singularity in a calculation of the state of the vehicle-manipulator coupling system and to ensure that a controller of the vehicle-manipulator coupling system does not diverge.

S103. In a case that constraint conditions corresponding to the finite time performance function are satisfied, the trajectory tracking error is converted to obtain a corresponding transformed error.

S104. A sliding mode surface of the vehicle-manipulator coupling system is designed based on the transformed error to control the transformed error to converge in a finite time, and an external disturbance of the vehicle-manipulator coupling system is observed based on a non-linear disturbance observer and the sliding mode surface.

S105. A control input of the vehicle-manipulator coupling system is designed based on the sliding mode surface and the external disturbance observed, so that the vehicle-manipulator coupling system is controlled to operate according to the desired trajectory. The control input includes the control signals of the underwater vehicle and the control signals of the robotic arm. The controller of the vehicle-manipulator coupling system controls the thrusters of the underwater vehicle to output corresponding control forces based on the underwater vehicle's control signals, and controls the joint motors of the robotic arm to output corresponding torques based on the robotic arm's control signals. This enables the underwater vehicle to move to the target position, after which the robotic arm performs the grasping action.

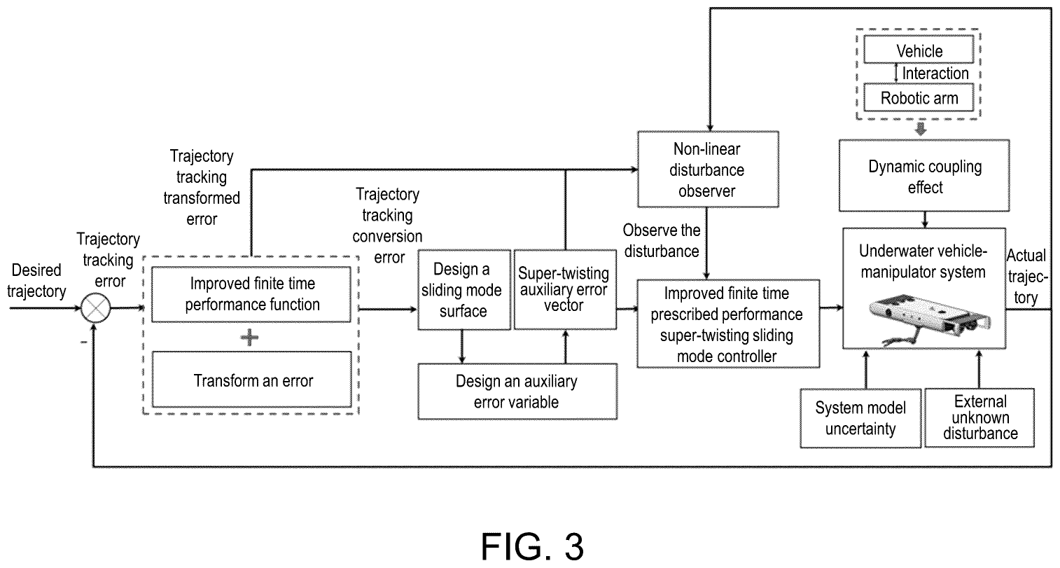

Specifically, a method for controlling the finite time prescribed performance of a dynamic trajectory tracking task directed to the underwater vehicle-manipulator system according to the disclosure, as shown in FIG. 3, includes the following:

(1) An improved finite time performance function is proposed to constrain a trajectory tracking error of the system;

(2) An error transformation method directed to the performance function is designed; and (3) A super-twisting sliding mode control algorithm based on the improved finite time prescribed performance of the non-linear disturbance observer is designed.

The improved finite time performance function proposed is as follows:

$${ρ}_{m} ( t ) = \{ \begin{matrix}{( {{ρ}_{0}}^{α} - αβ t )}^{1 / α} + {ρ}_{c} , & 0 \leq t < {T}_{m} \\ ( {ρ}_{c} - {ρ}_{∞} ) {e}^{- k ( t - {T}_{m} )} + {ρ}_{∞} , & t \geq {T}_{m}\end{matrix}$$

In the formula, ρₘ(t) represents a trajectory tracking error boundary; ρ₀ represents a preset initial error boundary; ρ_{c} represents a trajectory tracking error preset convergence boundary; ρ_{∞} represents the trajectory tracking error asymptotic convergence boundary; α, β, k represent prescribed performance parameters, used to adjust a convergence rate and a convergence time of the performance function; e represents a natural constant; t represents a time process; and Tₘ represents a convergence time of the performance function.

The improved finite time performance function has characteristics as follows:

(1) The convergence time Tₘ of the finite time performance function is calculated as: Tₘ=ρ₀^{α}/(αβ); (2) An actual initial error boundary of the finite time performance function is: ρₘ(0)=ρ₀+ρ_{c}; (3) When the trajectory tracking error converges to ρ_{c}, the system should reach a steady state. Therefore, when designing parameters, ρ_{c} should be designed to be small enough, usually 0.01, to satisfy the system convergence condition; (4) When the system time t≥Tₘ is used, in order to ensure that the gradient of the performance function designed is not zero, the design range of ρ_{∞} is 0<ρ_{∞}<ρ_{c}.

The formula of the performance function constraining the system trajectory tracking error is:

$${η}_{el} < {η}_{e} < {η}_{eu}$$

In the formula, ηₑ represents the system trajectory tracking error, and ηₑₗ and ηₑₗ represent a lower limit and an upper limit of the trajectory tracking error prescribed performance respectively and are defined by the following formula:

$${η}_{el} = - {k}_{l} {ρ}_{m} ( t ) , {η}_{eu} = {k}_{u} {ρ}_{m} ( t )$$

In the formula, kₗ and kᵤ represent performance boundary coefficients, and values thereof are in a range of 0<k₁≤1 and in a range of 0<kᵤ≤1 respectively. The system trajectory tracking error is defined as:

$${η}_{e} = η - {η}_{d}$$

In the formula, ηₑ represents the trajectory tracking error, η represents a system motion state, and η_{d} represents a system desired trajectory.

An error transformation method is represented by the following formula:

$$S ( {η}_{ε} ) = \frac{{k}_{u} {e}^{{η}_{ε}} - {k}_{l} {e}^{- {η}_{ε}}}{{e}^{{η}_{ε}} + {e}^{- {η}_{ε}}}$$

In the formula, η_{ε} represents an transformed system error, e represents the natural constant, S represents the error transformation method, and there are:

$$S ( {η}_{ε} ) = \frac{{η}_{e}}{{ρ}_{m}}$$

Therefore, below is obtained:

$${η}_{ε} = {S ( \frac{{η}_{e}}{{ρ}_{m}} )}^{- 1} = \frac{1}{2} ln \frac{ϛ + {k}_{l}}{{k}_{u} - ϛ}$$

In the formula, [symbol] =ηₑ/ρₘ.

For the super-twisting sliding mode control algorithm based on the improved finite time prescribed performance of the non-linear disturbance observer proposed, the design process is as follows.

Firstly, the system model expression is given:

$$\{ \begin{matrix}{\dot{x}}_{1} = {x}_{2} \\ {\dot{x}}_{2} = {A}_{m} {τ}_{m} + {B}_{m} + {F}_{dm}\end{matrix}$$

In the formula, x₁=η represents a system position state vector, x₂ represents a system speed state vector, Aₘ and Bₘ represent a matrix related to a dynamics model of the system, F_{dm} represents the external disturbance unknown received by the system, and τₘ represents a control input of the system.

Secondly, the sliding mode surface Sₘ is designed based on the transformed error η_{ε}:

$${S}_{m} = {λ}_{m} {η}_{ε} + {\dot{η}}_{ε}$$

In the formula, λₘ represents a diagonal sliding mode surface coefficient matrix.

Further, since F_{dm} is the unknown external disturbance, the non-linear disturbance observer is designed as follows to perform real-time estimation on F_{dm}:

$$\{ \begin{matrix}{\hat{F}}_{d m} = {α}_{d m} + {K}_{d m} {S}_{m} \\ {\dot{α}}_{d m} = - {L}_{d m} {α}_{d m} - {L}_{d m} ( {K}_{d m} {S}_{m} + {γ}^{- 1} {H}_{m} + {A}_{m} {τ}_{m} + {B}_{m} )\end{matrix}$$

In the formula, \hat{F}_{dm} represents the observation of the unknown external disturbance, α_{dm} represents an auxiliary intermediate variable of the non-linear disturbance observer, K_{dm} represents a gain coefficient of the observer to be designed, and K_{dm} satisfies K_{dm}=L_{dm}γ⁻¹.

Finally, the control algorithm is designed according to the following:

$${τ}_{m} = {A}_{m}^{- 1} [ - {B}_{m} - {\hat{F}}_{d m} - {γ}^{- 1} ( {H}_{m} + {k}_{α} {‖ {s}_{m} ‖}^{\frac{1}{2}} sign ( {s}_{m} ) + {\int }_{0}^{t} {k}_{γ} sign ( {s}_{m} ( τ ) ) d τ ) ]$$

In the formula, k_{α} and k_{γ} represent controller parameters to be designed.

It should be noted that the design idea of the control algorithm is as follows. The super-twisting sliding mode control approaching law is adopted so that the transformed error converges within a finite time and that the system tracking error ne satisfies the prescribed performance convergence boundary, and the system chattering effect can be weakened. The non-linear disturbance observer is introduced to improve system robustness under system uncertainty and external disturbance.

The disclosure uses the following embodiment to verify the above technical solution.

Basic parameters of the underwater vehicle-manipulator system according to an embodiment are shown in Table 1.

TABLE 1
Basic parameters of the underwater vehicle-manipulator system

| Parameter name | Parameter description | Parameter value | |
|---|---|---|---|
| Mᵥ | Underwater vehicle mass | 226 | kg |
| Lᵥ | Underwater vehicle length | 1.2 | m |
| Dᵥ | Underwater vehicle | 0.6 | m |
| | equivalent diameter | | |
| Gᵥ | Underwater vehicle gravity | 2217N | |
| Bᵥ | Underwater vehicle buoyancy | 2217N | |
| I_{v, xx} | Underwater vehicle moment | 8 | kg · m² |
| | of inertia-X | | |
| I_{v, yy} | Underwater vehicle moment | 20 | kg · m² |
| | of inertia-Y | | |
| I_{v, zz} | Underwater vehicle moment | 20 | kg · m² |
| | of inertia-Z | | |
| M₁ | Robotic arm link 1 mass | 3.39 | kg |
| M₂ | Robotic arm link 2 mass | 3.39 | kg |
| L₁ | Robotic arm link 1 length | 0.5 | m |
| L₂ | Robotic arm link 2 length | 0.5 | m |
| D₁ | Robotic arm link 1 diameter | 0.16 | m |
| D₂ | Robotic arm link 2 diameter | 0.16 | m |
| Cₘ | Inertia coefficient | 1.0 | |
| C_{d} | Drag coefficient | 1.1 | |
| ρ | Water density | 1000 | kg · m⁻³ |
| g | Acceleration of gravity | 9.8 | m · s⁻² |

This embodiment uses simulation to illustrate the effectiveness and advancement of the method proposed by this disclosure. In the simulation, the underwater vehicle completes a dynamic positioning control task, and the robotic arm mounted thereon completes complex sinusoidal motion to reflect the effectiveness of the control method proposed by this disclosure. Next, simulation parameter settings are introduced. For the dynamic positioning task of the underwater vehicle, an initial pose is

$${η}_{v , 0} = {[ 1 m 0 m 0.5 m \frac{0.1 π}{2} rad \frac{0.1 π}{2} rad \frac{0.3 π}{2} rad ]}^{T} ,$$

and an expected pose is η_{v,d}=[−3 m −3 m 4 m 0 rad 0 rad 0 rad]^{T}. For the robotic arm trajectory tracking task, an initial joint angle is q₀=[0rad 0rad]^{T}, and the expected joint angle changes with time t as

$${q}_{d} = {[ - 0.5 - \frac{π}{4} sin ( t ) rad - 0.5 - \frac{π}{4} sin ( t ) rad ]}^{T} .$$

In the control parameter aspect, for the robotic arm system, parameters are designed follows: α=0.4, β=0.8, k=0.2, ρ₀=[2 2], ρ_{c}=[0.03 0.03]^{T}, ρ_{∞}=[0.02 0.02]^{T}, κᵤ=1, κₗ=0.7, λₘ=diag(0.05,0.05), k_{α}=diag(25,25), k_{γ}=diag(20,20). For the underwater vehicle, control parameters are designed follows: α=0.2, β=0.8, k=0.3, ρ₀=[6 6 6 1 1 1]^{T}, ρ_{c}=[0.15 0.15 0.15 0.1 0.1 0.1]^{T}, ρ_{∞}=[0.1 0.1 0.1 0.05 0.05 0.05]^{T}, κᵤ=1, κₗ=1, λₘ=diag(0.1,0.1,0.1,0.1,0.1,0.1), κ_{α}=diag(500,500,500,400,400,400), κ_{γ}=diag(300,300,300,300,300,300), in which diag represents the diagonal matrix. The external disturbance received by the system is set to d₁=3+8sin(0.6 t)+5cos(0.3 t), and d₂=4+7sin(0.7 t)+4 cos(0.2 t). A parameter of the non-linear disturbance observer in the robotic arm system is designed as L_{dm}=diag(20,18), and a parameter of the observer of the underwater vehicle is designed as L_{dm}=diag(100,100,100,100,100,100).

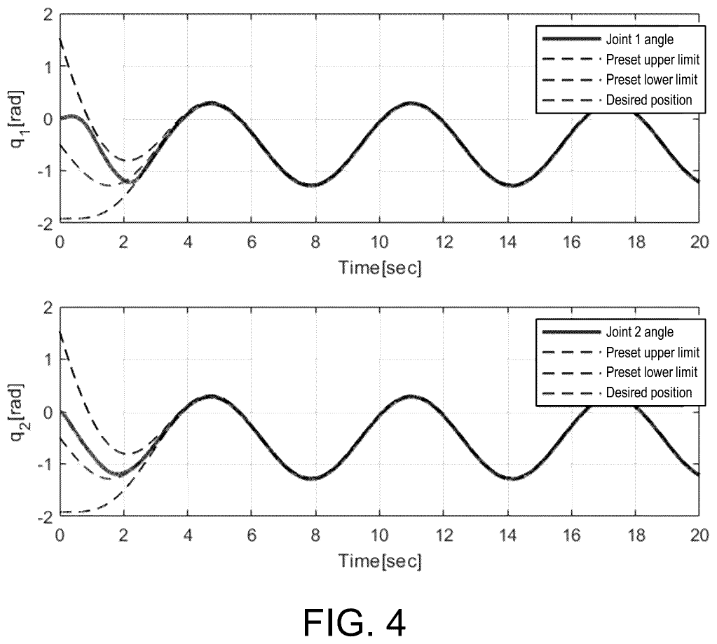

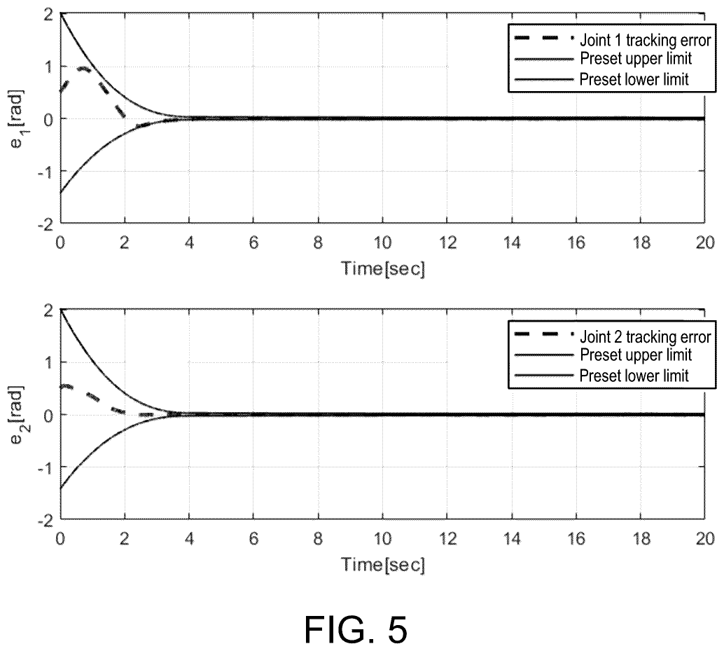

The simulation results are shown in FIG. 4 to FIG. 11. FIG. 4 shows trajectory tracking results of the robotic arm with two joints, and FIG. 5 shows trajectory tracking errors of the two joints. The simulation results show that the convergence time of the method proposed by this disclosure is less than 4 s, the convergence is fast, and the convergence time is controllable. In addition, the trajectory tracking steady-state error of the method according to the disclosure is less than 0.01 rad. The Calculation shows that for a joint 1 and a joint 2, average steady-state tracking errors of the method according to the disclosure are −6.30×10⁻⁴ rad and 2.33×10⁻³ rad respectively, and the control precision is high.

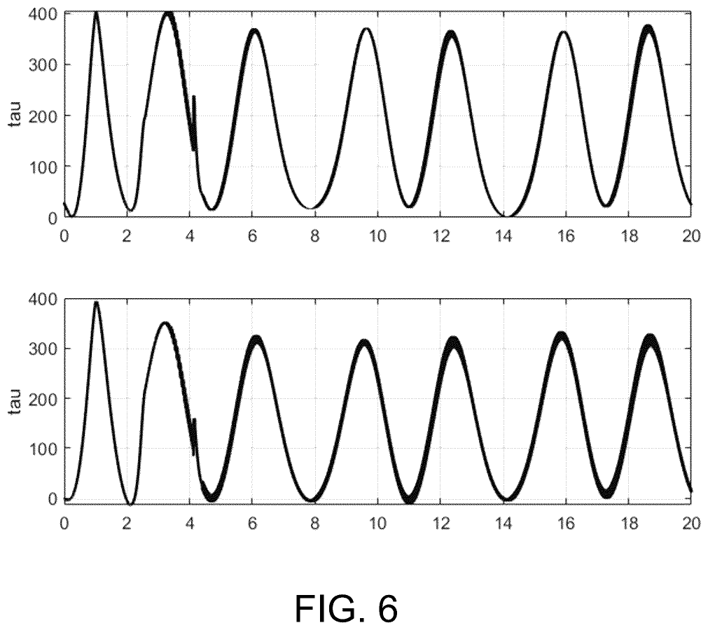

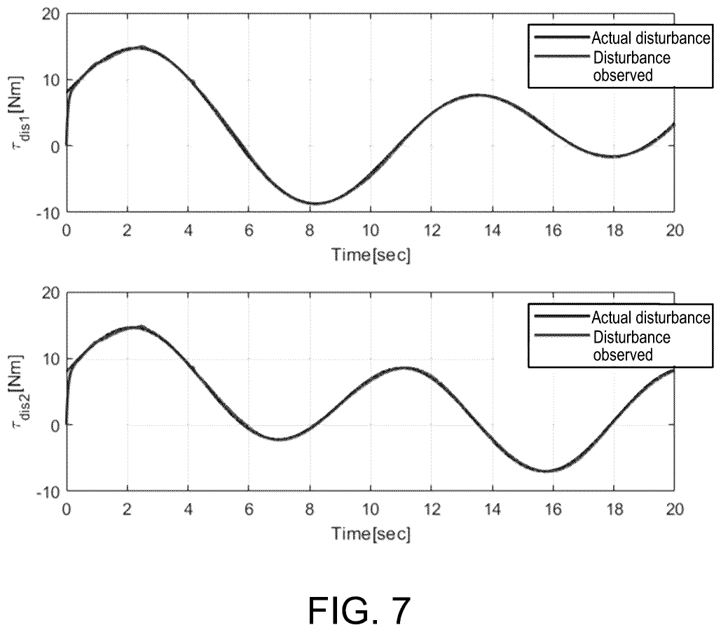

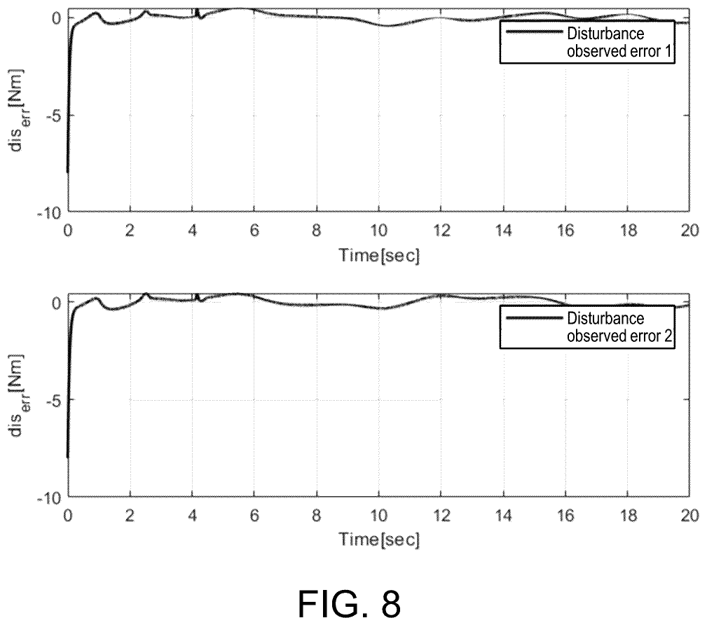

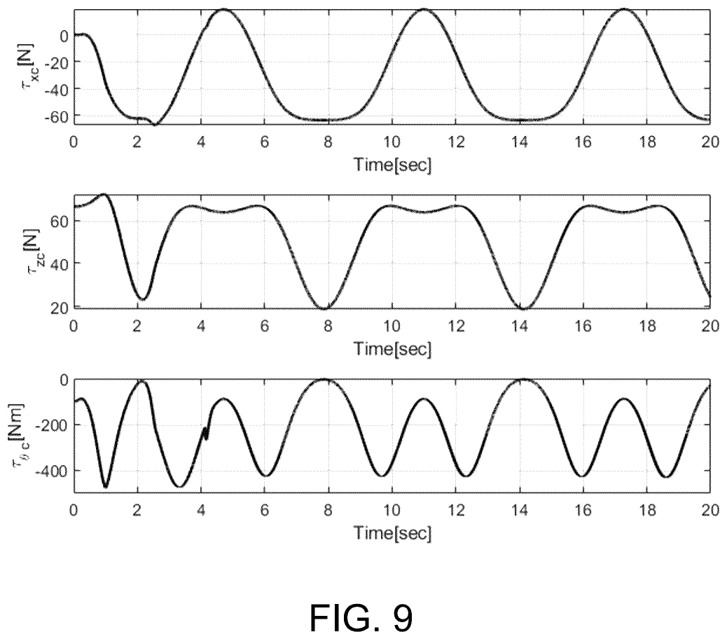

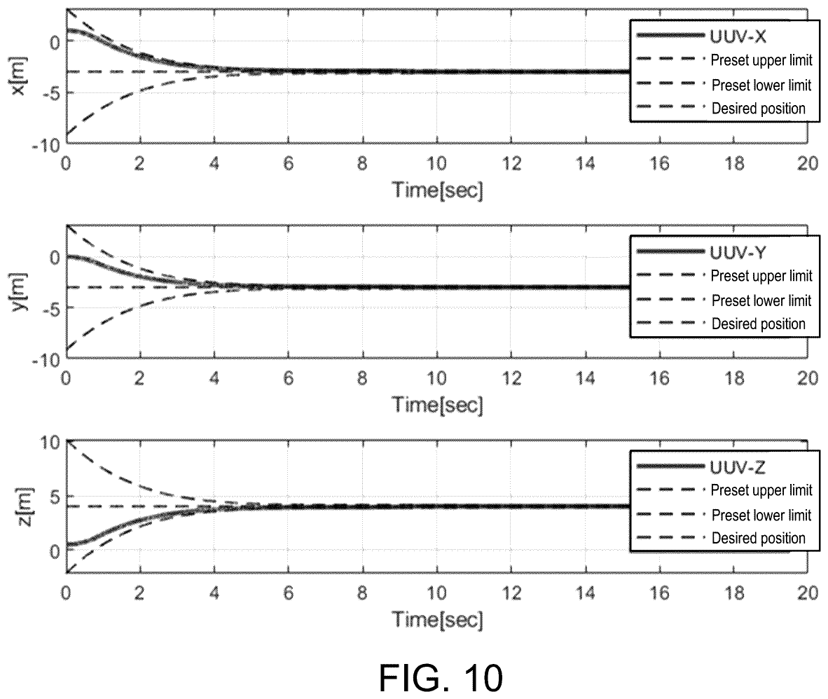

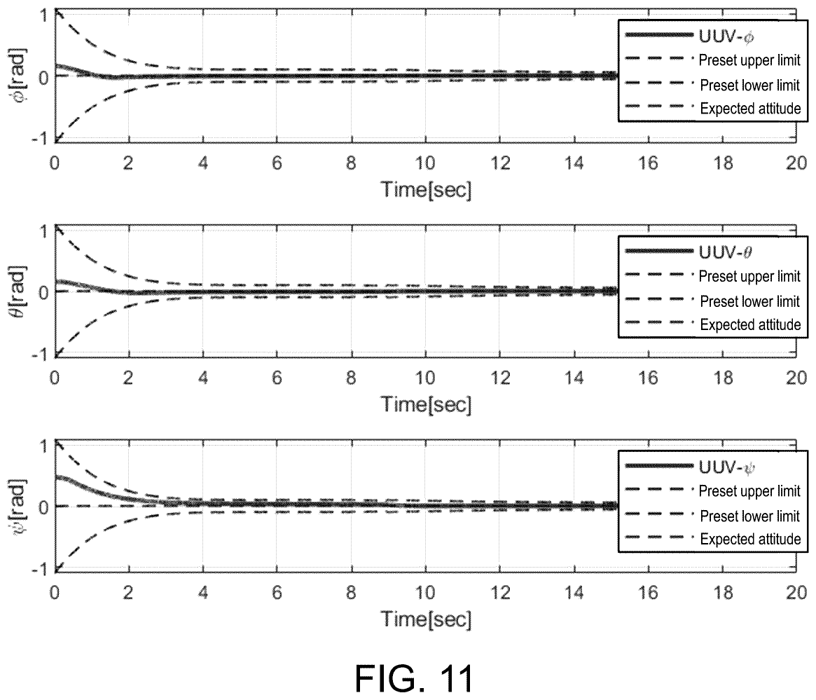

FIG. 6 shows control inputs of the joint 1 and the joint 2. It may be concluded from FIG. 6 that when the method according to the disclosure is adopted, the chattering effect is significantly weakened. FIG. 7 and FIG. 8 show the observation performance of the non-linear disturbance observer, the observer may stably estimate external disturbance, and the observation values may converge in a short time. Specifically, the average steady-state estimation errors of disturbance 1 and disturbance 2 are −4.18×10⁻² Nm and −1.29×10⁻² Nm respectively. Finally, the dynamic positioning control performance of the underwater vehicle is briefly demonstrated. When working together with the robotic arm, the underwater vehicle is affected by the dynamic coupling effect. Since the robotic arm of 2 degrees of freedom merely operates in an xoz plane of an underwater vehicle boat body coordinate system, the dynamic coupling effect merely affects three degrees of freedom, x, z, and θ of the underwater vehicle, as shown in FIG. 9. FIG. 10 and FIG. 11 respectively show dynamic positioning position errors and attitude errors of the underwater vehicle under the action of external disturbance and coupling disturbance, in which steady-state position errors on three degrees of freedom, x, y, z, are respectively −1.39×10⁻⁴ m, 3.05×10⁻³ m, 4.30×10⁻⁴ m, and steady-state attitude errors on three degrees of freedom ϕ, θ, ψ are respectively 9.21×10⁻³ rad, −1.42×10⁻² rad, 2.05×10⁻⁴ rad, the control precision is high, and the convergence time is fast, approximately 4 s. The above analysis shows that the method proposed by the disclosure has good transient-state and steady-state control performances.

In summary, the disclosure discloses the method for the finite time prescribed performance control of the dynamic trajectory tracking task directed to the underwater vehicle-manipulator system. Under the influence of model uncertainty, dynamic coupling effects, and external disturbances, the trajectory tracking control of the underwater vehicle-manipulator systems faces big challenges. In order to ensure the transient-state and steady-state performances of the system, the improved finite time performance function is designed to ensure that the preset tracking precision is achieved in a specified convergence time. The performance function proposed can avoid generating a singularity in the system, and the robustness of the system is improved. In order to reduce the influence of unknown external disturbances on the system, the non-linear disturbance observer is adopted to process unknown disturbances. Finally, the super-twisting sliding mode control framework based on the improved finite time prescribed performance of the non-linear disturbance observer is proposed, which ensures the control precision, robustness, and transient-state performance of the system, and the buffeting phenomenon is weakened.

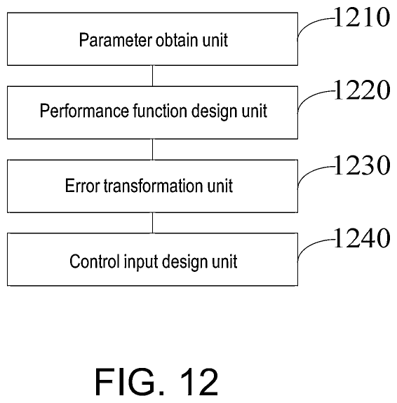

FIG. 12 is a diagram of an architecture of a system for the finite time prescribed performance control of trajectory tracking for the vehicle-manipulator coupling system according to an embodiment of the disclosure. As shown in FIG. 12, the control system includes the following.

A parameter obtain unit 1210 is used to obtain the present motion state and the desired trajectory of the vehicle-manipulator coupling system, so as to calculate a difference between the present motion state and the desired trajectory to obtain a trajectory tracking error.

A performance function design unit 1220 is used to design a finite time performance function to constrain the trajectory tracking error so that when the trajectory tracking error converges to a preset convergence boundary, the vehicle-manipulator coupling system reaches a steady state, and when an operation time of the vehicle-manipulator coupling system exceeds a preset convergence time, a gradient of the finite time performance function is not zero, so as to avoid generating a singularity in a calculation of the state of the vehicle-manipulator coupling system and to ensure that a controller of the vehicle-manipulator coupling system does not diverge.

An error transformation unit 1230 is used to convert the trajectory tracking error to obtain the corresponding transformed error in a case that constraint conditions corresponding to the finite time performance function are satisfied.

A control input design unit 1240 is used to design the sliding mode surface of the vehicle-manipulator coupling system based on the transformed error to control the transformed error to converge in a finite time, and to observe the external disturbance of the vehicle-manipulator coupling system based on the non-linear disturbance observer and the sliding mode surface; and to design the control input of the vehicle-manipulator coupling system based on the sliding mode surface and external disturbance observed, so that the vehicle-manipulator coupling system is controlled to operate according to the desired trajectory.

It should be understood that the control system is used to execute the method in the embodiments, and corresponding program units in the control system have implementation principles and technical effects similar to the contents described in the method. For the working process of the control system, reference may be made to corresponding processes in the method described above, and details will not be repeated here.

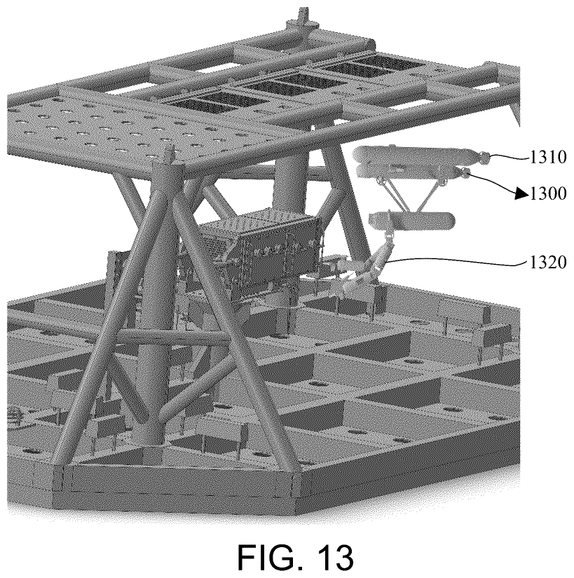

The following uses the operation and maintenance tasks of the underwater oil and gas production system as the application scenario for the vehicle-manipulator coupling system. FIG. 13 is a schematic diagram illustrating the operation and maintenance tasks of the underwater oil and gas production system according to the embodiment of the present disclosure. In this embodiment, an underwater vehicle-manipulator system (UVMS) 1300 serves as the vehicle-manipulator coupling system.

The UVMS 1300 includes an underwater vehicle 1310 (mother craft) and a robotic arm 1320 according to FIG. 13. As shown in FIG. 13, the operational workspace of the UVMS 1300 is narrow and complex. If only steady-state control accuracy is ensured, the UVMS 1300 may collide with underwater structures before reaching steady state due to excessive control overshoot, slow convergence rate, and the intricate underwater environment. Therefore, it is essential to guarantee excellent transient performance of the UVMS 1300, constraining its state within a global safety envelope to avoid collisions with underwater structures while strictly controlling the convergence time.

If conventional finite-time prescribed performance functions are used, the gradient of the performance function becomes zero once the UVMS 1300 reaches steady state. In such a case, if the UVMS 1300 is subjected to strong impulsive disturbances and its state approaches or crosses the prescribed performance boundary, the control algorithm—lacking a performance function gradient—will encounter singularities, leading to control divergence. This results in uncontrollable system states, increasing collision risks and potentially causing mission failure or system damage.

To address this issue, the finite-time performance function designed in this embodiment incorporates preset convergence boundary technology, ensuring global non-singularity of the UVMS 1300. This effectively resolves the control divergence problem that conventional finite-time prescribed performance control systems are prone to after reaching steady state.

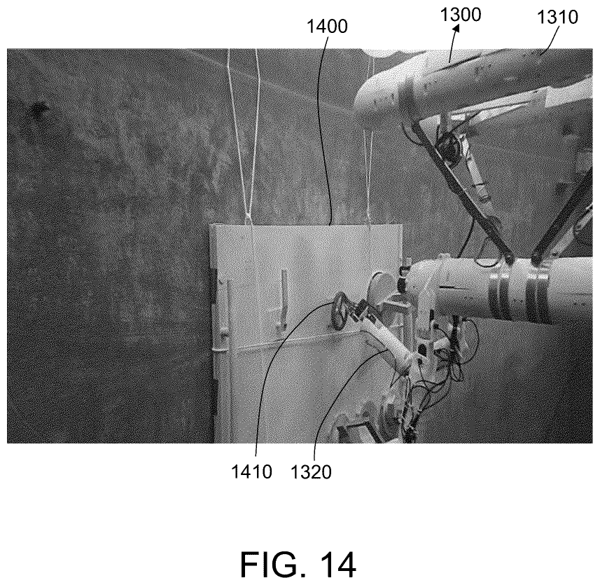

FIG. 14 is a schematic diagram of the embodiment of the vehicle-manipulator coupling system for wheel-type valve operation testing according to the embodiments. In this embodiment, a real-vehicle test was conducted based on a simulated operational scenario of control panel 1400 in the maintenance tasks of a subsea oil and gas production system. First, the underwater vehicle 1310 achieves visual-servo dynamic hovering using the wheel-type valve 1410 as a reference. Then, as the underwater vehicle 1310 approaches the control panel 1400, the wheel-type valve 1410 gradually enters the operational workspace of the vehicle-manipulator coupling system 1300. The robotic arm 1320, based on visual positioning information and combined with the proposed coupling-weakened trajectory planning method, generates a desired trajectory with weakly coupled characteristics to approach the wheel-type valve 1410 and accomplish precise grasping. Finally, the end-effector (e.g., the gripper at the end of the robotic arm 1320) rotates 90 degrees clockwise to complete the valve-turning operation.

For example, the target coordinates of the wheel-type valve 1410's center in the binocular camera coordinate system of underwater vehicle 1310 are set to [0.4 m, −0.05 m, 0 m], with both the target roll and pitch angles of underwater vehicle 1310 set to 0°. Subsequently, underwater vehicle 1310 maneuvers toward control panel 1400 to approach it. When underwater vehicle 1310 has moved toward control panel 1400 for 15.6 seconds, control panel 1400 enters the operational range of vehicle-manipulator coupling system 1300. At this point, robotic arm 1320 initiates movement and approaches wheel-type valve 1410. Under the control of vehicle-manipulator coupling system 1300's controller, underwater vehicle 1310 effectively counteracts coupling disturbances induced by the weakly-coupled robotic arm 1320's motion. The vehicle maintains high positioning accuracy and stability throughout the operation, with all positioning errors constrained within the safety performance envelope. Although a steady-state tracking error of 0.035 m persists along the z-axis, and maximum pitch angle fluctuations of 0.57° occur after robotic arm 1320 begins to move, these deviations are actively compensated by robotic arm 1320 without compromising precise capture of the target (wheel-type valve 1410).

During the time interval of 15.6 s to 28.6 s, robotic arm 1320 gradually approaches the center of wheel-type valve 1410 based on visual perception data and achieves precise grasping. Valve rotation commences at 33.6 s, with the wheel-type valve 1410 rotation task successfully completed in 4.6 seconds.

In other embodiments, the vehicle-manipulator coupling system is used for a T-type valve, and its related operations are similar to those of the wheel-type valve 1410, which will not be described in detail here.

The disclosure provides a coupling weaken trajectory planning method for reducing the dynamic coupling effect of the vehicle-manipulator coupling system. Firstly, the dynamic equation of the vehicle-manipulator coupling system can be written as follows:

$${M}_{ν} \dot{v} + {C}_{ν} ( v ) v + {D}_{v} ( v ) v + {G}_{v} ( {η}_{ν 2} ) - {M}_{mv , q} ( q ) \ddot{q} - {M}_{mv , v} ( q ) \dot{v} - {C}_{mv} ( q , \dot{q} , v ) - {D}_{mv} ( q , \dot{q} , v ) - {G}_{mv} ( q , {η}_{ν 2} ) = 0.$$

Where Mᵥ includes a rigid body inertia matrix and an added mass inertia matrix of the underwater vehicle, Cᵥ(v) includes a vehicle coriolis centripetal force matrix of rigid body and a coriolis centripetal force matrix of added mass, Dᵥ(v) denotes a damping matrix of the underwater vehicle, Gᵥ(ηᵥ₂) denotes a gravity and a buoyancy of the underwater vehicle, M_{mv,q}(q) denotes a coupling inertial matrix induced by an acceleration of the robotic arm, Cₘᵥ(q,\dot{q},v) denotes a coupling coriolis centripetal force and a moment acting on the underwater vehicle induced by the coupling velocity of the robotic arm and the underwater vehicle, Dₘᵥ(q,\dot{q},v) denotes a coupling damping force and a moment acting on the vehicle induced by the coupling velocity of the robotic arm and the underwater vehicle, Gₘᵥ(q,ρᵥ₂) denotes a coupling buoyancy and a gravity force and a moment of the robotic arm acting on the underwater vehicle. The parameters of the above matrices can be obtained by an empirical formula of the hydrodynamics or the towing test. v denotes a velocity vector of the underwater vehicle, ρᵥ₂ denotes an attitude vector of the underwater vehicle. Both of them can be obtained by an onboard attitude sensor, such as the inertial measurement unit (IMU). \dot{v} denotes an acceleration vector of the underwater vehicle, which can be obtained by a velocity differentiation process. q denotes a joint angle vector of the robotic arm, \dot{q} denotes a joint angular velocity vector of the robotic arm, \ddot{q} denotes a joint angular acceleration vector of the robotic arm. The above three parameters can be obtained by a motor encoder of each joint.

The dynamic equation of the vehicle-manipulator coupling system can be transformed into:

$$[ {M}_{ν} - {M}_{mv , v} ( q ) ] \dot{v} = [ ( {C}_{mv} ( q , \dot{q} , v ) + {D}_{mv} ( q , \dot{q} , ν ) + {G}_{mv} ( q , {η}_{v 2} ) - {C}_{v} ( v ) v - {D}_{v} ( v ) v - {G}_{v} ( {η}_{ν 2} ) ) {\ddot{q}}^{†} + {M}_{m ν , q} ( q ) ] \ddot{q} .$$

Where \ddot{q}^{†} denotes a normalized inverse vector of the joint angular acceleration, which is designed as:

$${\ddot{q}}^{†} = [ \frac{{\ddot{q}}_{1}}{{‖ \ddot{q} ‖}^{2}} , \frac{{\ddot{q}}_{2}}{{‖ \ddot{q} ‖}^{2}} , … , \frac{{\dot{q}}_{n}}{{‖ \ddot{q} ‖}^{2}} ] .$$

Where n denotes the number of the joints of the robotic arm, \ddot{q}ᵢ(with i=1,2, . . . , n) denotes the i^{th} joint acceleration of the robotic arm. Then the following equation can be obtained:

\dot{v}=V_{coupling}_{ₘᵥ}\ddot{q}.

Where V_{coupling}_{ₘᵥ} is designed as a coupling characteristic index, which can be written as:

$${V}_{c o {upling}_{mv}} = {V}_{c v}^{- 1} {V}_{c m} .$$

$$Where :$$

$${V}_{c v} = {M}_{v} - {M}_{mv , v} ( q ) \cdot {V}_{c m} = [ {C}_{m v} ( q , \dot{q} , v ) + {D}_{m v} ( q , \dot{q} , v ) + {G}_{m v} ( q , {η}_{v 2} ) - {C}_{v} ( v ) v - {D}_{v} ( v ) v - {G}_{v} ( {η}_{v 2} ) ] {\ddot{q}}^{†} + {M}_{mv , q} ( q )$$

The provided coupling characteristic index V_{coupling}_{ₘᵥ} reveals the motion coupling relationship between the robotic arm and the underwater vehicle. In order to quantify the coupling effects of the vehicle-manipulator coupling system, a singular value decomposition of V_{coupling}_{ₘᵥ} is conducted, and a weighted average for each singular value can be obtained as S_{coupling}, which is related to the system trajectory characteristic v, \dot{v}, ηᵥ₂, q, \dot{q}, \ddot{q}. Then it can be written as S_{coupling}(v, \dot{v}, ηᵥ₂, q, \dot{q}, \ddot{q}), and technicians can know that the smaller S_{coupling}(v, \dot{v}, ηᵥ₂, q, \dot{q}, \ddot{q}), a weakly coupling characteristic can be got. Then, the coupling weaken trajectory planning method can be designed as:

$$min J ( v , \dot{v} , {η}_{v 1} , {η}_{v 2} , q , \dot{q} , \ddot{q} ) = {κ}_{1} {S}_{coupling} ( v , \dot{v} , {η}_{v 2} , q , \dot{q} , \ddot{q} ) + {κ}_{2} {D}_{target} ( {η}_{v 1} , {η}_{v 2} , q ) .$$

Where J(v, \dot{v}, ηᵥ₂, q, \dot{q}, \ddot{q}) denotes an optimization function with respect to the desired trajectory v, \dot{v}, ηᵥ₁, ηᵥ₂, q, \dot{q}, \ddot{q}, ηᵥ₁ denotes a position vector of the underwater vehicle, which can be obtained by a camera system. D_{target}(ηᵥ₁,ηᵥ₂,q) denotes a distance between an end effector of the robotic arm and the target, which can be obtained by the camera system. The coupling weaken trajectory planning method is to find the minimum value of J(v, \dot{v}, ηᵥ₂, q, \dot{q}, \ddot{q}), then the desired trajectory with weakly coupling characteristic can be obtained.

Based on the method according to the embodiments, an electronic device is provided according to an embodiment of the disclosure. The device may include at least one storage device for storing programs and at least one processor for executing the programs stored in the storage device, in which when the program stored in the storage device is executed, the processor is used to execute the method according to the embodiments.

Based on the method according to the embodiments, a computer-readable storage medium is provided according to an embodiment of the disclosure. The computer-readable storage medium stores a computer program, in which when the computer program is run on the processor, the processor executes the method according to the embodiments.

Based on the method according to the embodiments, a computer program product is provided according to an embodiment of the disclosure. When the computer program product is run on the processor, the processor executes the method according to the embodiments.

It may be understood that the processor in the embodiments of the disclosure may be a central processing unit (CPU), or other general-purpose processor, digital signal processor (DSP), application specific integrated circuit (ASIC), field programmable gate array (FPGA), or other programmable logic devices, transistor logic devices, hardware components, or any combination thereof. The general-purpose processor may be a microprocessor or any regular processor.

The steps in the method according to the embodiments of the disclosure may be implemented by hardware or by the processor executing software commands. The software commands may comprise corresponding software modules, and the software modules may be stored in random access memory (RAM), flash memory, read-only memory (ROM), programmable rom (PROM), erasable PROM (EPROM), electrically EPROM (EEPROM), register, hard disk, portable storage device, CD-ROM, or any other forms of storage medium well known in the art. An exemplary storage medium is coupled to a processor so that the processor may read information from the storage medium and write information to the storage medium. Certainly, the storage medium may also be an integral part of the processor. The processor and the storage medium may be located in the ASIC.

The above embodiments may be implemented in whole or in part by software, hardware, firmware, or any combination thereof. When implemented using software, the disclosure may be implemented in whole or in part in the form of a computer program product. The computer program product includes one or more computer commands. When the computer program commands are loaded and executed on a computer, the processes or functions described in the embodiments of the disclosure are generated in whole or in part. The computer may be a general-purpose computer, a special-purpose computer, a computer network, or other programmable devices. The computer command may be stored in the computer-readable storage medium or transmitted over the computer-readable storage medium. The computer command may be transmitted from a website, computer, server, or data center via wired (such as coaxial cable, optical fiber, digital subscriber line (DSL)) or wireless (such as infrared, wireless, microwave) transmission to another website, computer, server, or data center. The computer-readable storage medium may be any available medium accessible by a computer, or a data storage device such as and integrated server comprising one or more available media, for example, a server or a data center. The available medium may be a magnetic medium (for example, a floppy disk, a hard disk, a magnetic tape), an optical medium (for example, a DVD), or a semiconductor medium (for example, a solid state disk (SSD)).

It may be understood that the various reference numerals involved in the embodiments of the disclosure are merely for convenience of description and are not used to limit the scope of the embodiments of the disclosure.

It may be understood for persons skilled in the art that the embodiments are merely some preferred embodiments of the disclosure and the embodiments are not intended to limit the disclosure. Any modifications, equivalent substitutions, and improvements made within the spirit and principles of the disclosure shall be regarded as should be included within the protection scope of the disclosure.

What is claimed is:

1. A method for trajectory tracking control of a vehicle-manipulator coupling system with finite time prescribed performance, the method is applied to the vehicle-manipulator coupling system to control a motion trajectory of the vehicle-manipulator coupling system, the vehicle-manipulator coupling system comprises an underwater vehicle and a robotic arm, and the method comprises following steps:
obtaining a present motion state, and a desired trajectory with a weakly coupling characteristic of the vehicle-manipulator coupling system is obtained by a coupling weaken trajectory planning method, so as to calculate a difference between the present motion state and the desired trajectory to obtain a trajectory tracking error;
designing a finite time performance function to constrain the trajectory tracking error so that the vehicle-manipulator coupling system reaches a steady state in response to the trajectory tracking error converging to a preset convergence boundary; and a gradient of the finite time performance function is not zero in response to an operation time of the vehicle-manipulator coupling system exceeding a preset convergence time, so as to avoid generating a singularity in a calculation of the state of the vehicle-manipulator coupling system and to ensure that a controller of the vehicle-manipulator coupling system does not diverge;
converting the trajectory tracking error to obtain a corresponding transformed error in a case that constraint conditions corresponding to the finite time performance function are satisfied;
designing a sliding mode surface of the vehicle-manipulator coupling system based on the transformed error to control the transformed error to converge in a finite time, and observing an external disturbance of the vehicle-manipulator coupling system based on a non-linear disturbance observer and the sliding mode surface;
designing a control input of the vehicle-manipulator coupling system based on the sliding mode surface and an external disturbance observer, so that the vehicle-manipulator coupling system is controlled to operate according to the desired trajectory;
wherein designing the control input of the vehicle-manipulator coupling system based on the sliding mode surface and the external disturbance observer specifically is:
$${τ}_{m} = {A}_{m}^{- 1} [ - {B}_{m} - {\hat{F}}_{d m} - {γ}^{- 1} ( {H}_{m} + {k}_{α} {‖ {s}_{m} ‖}^{\frac{1}{2}} sign ( {S}_{m} ) + {\int }_{0}^{t} {k}_{γ} sign ( {s}_{m} ( τ ) ) d τ ) ] ,$$
wherein
τₘ represents a control input, k_{aα} and k_{γ} represent controller parameters to be designed, sign(·) represents a signum function, τ0 represents the time, sₘ(τ) represents a value of sₘ at the time τ, sₘ represents the sliding mode surface, ∫₀^{t}k_{γ}sign(sₘ(τ))dτ represents an integral of k_{γ}sign(sₘ) at a time interval [0, t]; Aₘ and Bₘ represent a matrix related to a dynamics model of the vehicle-manipulator coupling system; \hat{F}_{dm} represents observation of a unknown external disturbance;
$$γ = \frac{( {κ}_{u} + {κ}_{l} ) {ρ}_{m}}{2 ( {κ}_{l} {ρ}_{m} + {η}_{e} ) ( {κ}_{u} {ρ}_{m} - {η}_{e} )} ,$$
κₗ and κᵤ represent performance boundary coefficients, ηₑ represents the trajectory tracking error, ρₘ is an abbreviation of ρₘ(t), and ρₘ(t) represents a trajectory tracking error boundary; and
$${H}_{m} = ( {λ}_{m} γ + \dot{γ} ) ( {\dot{η}}_{e} - \frac{{η}_{e} {\dot{ρ}}_{m}}{{ρ}_{m}} ) - γ \cdot \frac{{\dot{η}}_{e} {\dot{ρ}}_{m} {ρ}_{m} + {η}_{e} {\ddot{ρ}}_{m} {ρ}_{m} - {η}_{e} {\dot{ρ}}_{m}^{2}}{{ρ}_{m}^{2}} - γ {\ddot{η}}_{d} ,$$
\dot{γ} represents a first order derivative of γ, \ddot{ρ}ₘ is an abbreviation of \ddot{ρ}ₘ(t) being a second order derivative of ρₘ(t), \ddot{n}_{d} represents a second order derivative of the desired trajectory η_{d}, \dot{η}ₑ represents a first order derivative of the trajectory tracking error ηₑ, λₘ represents a diagonal sliding mode surface coefficient matrix, and \dot{ρ}ₘ is an abbreviation of \dot{ρ}ₘ(t) being the first order derivative of ρₘ(t),
wherein the control input includes control signals of the underwater vehicle and control signals of the robotic arm, the controller of the vehicle-manipulator coupling system controls thrusters of the underwater vehicle to output corresponding control forces based on the control signals of the underwater vehicle, and controls joint motors of the robotic arm to output corresponding torques based on the control signals of the robotic arm, such that the robotic arm performs a grasping action after the underwater vehicle moves to a target position.

2. The method according to claim 1, wherein the improved finite time performance function is:
$${ρ}_{m} ( t ) = \{ \begin{matrix}{( {ρ}_{0}^{α} - α β t )}^{1 / α} + {ρ}_{c} , 0 \leq t < {T}_{m} \\ ( {ρ}_{c} - {ρ}_{∞} ) {e}^{- k ( t - {T}_{m} )} + {ρ}_{∞} , t \geq {T}_{m}\end{matrix} ,$$
wherein
ρ₀ represents a preset initial error boundary, and ρ₀>0; ρ_{c} represents a trajectory tracking error preset convergence boundary, and 0<ρ_{c}<<ρ₀; ρ_{∞} represents a trajectory tracking error asymptotic convergence boundary, and 0<ρ_{∞}<ρ_{c}; α, β, k represent prescribed performance parameters, configured to adjust a convergence rate and a convergence time of the finite time performance function; e represents a natural constant; t represents a time process; and Tₘ represents a preset convergence time, and Tₘ=ρ₀^{α}/(αβ).

3. The method according to claim 2, wherein ηₑ represent the trajectory tracking error, ηₑ=η−η_{d}, η represents the present motion state, and n_{d} represents the desired trajectory;
the finite time performance function constraining the trajectory tracking error specifically is:
$$- {k}_{l} {ρ}_{m} ( t ) < {η}_{e} < {k}_{u} {ρ}_{m} ( t ) .$$

4. The method according to claim 3, wherein error transformation is performed on the trajectory tracking error ηₑ in order to satisfy constraining the finite time performance function, the transformed error is represented by η_{ε},:
$${η}_{ε} = \frac{1}{2} ln \frac{ϛ + {k}_{l}}{{k}_{u} - ϛ} ,$$
wherein [symbol]
=ηₑ/ρₘ, and the first order derivative \dot{η}_{ε} of the transformed error η_{ε} is :
$${\dot{η}}_{ε} = γ ( {\dot{η}}_{e} - \frac{{η}_{ε} {\dot{ρ}}_{m}}{{ρ}_{m}} ) .$$

5. The method according to claim 4, wherein a motion model of the vehicle-manipulator coupling system is represented by:
$$\{ \begin{matrix}{\dot{x}}_{1} = {x}_{2} \\ {\dot{x}}_{2} = {A}_{m} {τ}_{m} + {B}_{m} + {F}_{dm}\end{matrix} ,$$
wherein
x₁ =η, x₂ represents a speed state vector, F_{dm} represents the unknown external disturbance received by the vehicle-manipulator coupling system;
designing the sliding mode surface Sₘ based on the transformed error η_{ε}:
$${S}_{m} = {λ}_{m} {η}_{ε} + {\dot{η}}_{ε} .$$

6. The method according to claim 5, wherein observing the external disturbance of the vehicle-manipulator coupling system based on the non-linear disturbance observer and the sliding mode surface specifically is:
$$\{ \begin{matrix}{\hat{F}}_{d m} = {α}_{d m} + {K}_{d m} {S}_{m} \\ {\dot{α}}_{d m} = - {L}_{d m} {α}_{d m} - {L}_{d m} ( {K}_{d m} {S}_{m} + {γ}^{- 1} {H}_{m} + {A}_{m} {τ}_{m} + {B}_{m} )\end{matrix} ,$$
wherein
α_{dm} represents an auxiliary intermediate variable of the non-linear disturbance observer, L_{dm} and K_{dm} represent gain coefficients of the non-linear disturbance observer, and K_{dm} satisfies K_{dm}=L_{dm}γ⁻¹.

7. The method according to claim 1, wherein the coupling weaken trajectory planning method uses a dynamic equation of the vehicle-manipulator coupling system, which is written as follows:
$${M}_{v} \dot{v} + {C}_{v} ( v ) v + {D}_{v} ( v ) v + {G}_{v} ( {η}_{v 2} ) - {M}_{mv , q} ( q ) \ddot{q} - {M}_{mv , v} ( q ) \dot{v} - {C}_{mv} ( q , \dot{q} , v ) - {D}_{mv} ( q , \dot{q} , v ) - {G}_{mv} ( q , {η}_{v 2} ) = 0 ,$$
wherein Mᵥ includes a rigid body inertia matrix and an added mass inertia matrix of the underwater vehicle, Cᵥ(v) includes a vehicle coriolis centripetal force matrix of rigid body and a coriolis centripetal force matrix of added mass, Dᵥ(v) denotes a damping matrix of the underwater vehicle, Gᵥ(ηᵥ₂) denotes a gravity and a buoyancy of the underwater vehicle, M_{mv,q}(q) denotes a coupling inertial matrix induced by an acceleration of the robotic arm, Cₘᵥ(q,\dot{q},v) denotes a coupling coriolis centripetal force and a moment acting on the underwater vehicle induced by the coupling velocity of the robotic arm and the underwater vehicle, Dₘᵥ(q,\dot{q},v) denotes a coupling damping force and a moment acting on the vehicle induced by the coupling velocity of the robotic arm and the underwater vehicle, Gₘᵥ(q,ηᵥ₂) denotes a coupling buoyancy and a gravity force and a moment of the robotic arm acting on the underwater vehicle, v denotes a velocity vector of the underwater vehicle, ηᵥ₂ denotes an attitude vector of the underwater vehicle, \dot{v} denotes an acceleration vector of the underwater vehicle, q denotes a joint angle vector of the robotic arm, \dot{q} denotes a joint angular velocity vector of the robotic arm, \ddot{q} denotes a joint angular acceleration vector of the robotic arm, the above three parameters q, \dot{q}, \ddot{q} are obtained by a motor encoder of each joint,
the dynamic equation of the vehicle-manipulator coupling system is transformed into:
$$[ {M}_{v} - {M}_{mv , v} ( q ) ] \dot{v} = [ \text{} ( {C}_{mv} ( q , \dot{q} , v ) + {D}_{mv} ( q , \dot{q} , v ) + {G}_{mv} ( q , {η}_{v 2} ) - {C}_{v} ( v ) v - {D}_{v} ( v ) v - {G}_{v} ( {η}_{v 2} ) ) {\ddot{q}}^{†} + {M}_{mv , q} ( q ) ] \ddot{q} ,$$
wherein \ddot{q}^{†} denotes a normalized inverse vector of the joint angular acceleration, \dot{v}=V_{coupling}_{ₘᵥ}\ddot{q}, V_{coupling}_{ₘᵥ}=⁻¹V_{cm} is designed as a coupling characteristic index,
$${V}_{c v} = {M}_{v} - {M}_{mv , v} ( q )$$
$${V}_{c m} = [ {C}_{m v} ( q , \dot{q} , v ) + {D}_{m v} ( q , \dot{q} , v ) + {G}_{m v} ( q , {η}_{v 2} ) - {C}_{v} ( v ) v - {D}_{v} ( v ) v - {G}_{v} ( {η}_{v 2} ) ] {\ddot{q}}^{†} + {M}_{m v , q} ( q ) .$$

8. The method according to claim 7, wherein the coupling characteristic index V_{coupling}_{ₘᵥ} is processed by a singular value decomposition, and a coupling intensity of the vehicle-manipulator coupling system is quantitatively presented by
$${S}_{coupling} ( v , \dot{v} , {η}_{v 2} , q , \dot{q} , \ddot{q} ) = \frac{{s}_{1} {ω}_{1} + {s}_{2} {ω}_{2} + … + {s}_{m} {ω}_{m}}{m} ,$$
where ωᵢ denotes an i^{th} singular value of V_{coupling}_{ₘᵥ}, sᵢ denotes weight coefficients to be designed, i=1,2, . . . , m, m denotes a number of the singular values of V_{coupling}_{ₘᵥ},
wherein the coupling weaken trajectory planning method, used to obtain the desired trajectory with the weakly coupling characteristic, is designed as:
$$min J ( v , \dot{v} , {η}_{v 1} , {η}_{v 2} , q , \dot{q} , \ddot{q} ) = {κ}_{1} {S}_{coupling} ( v , \dot{v} , {η}_{v 2} , q , \dot{q} , \ddot{q} ) + {κ}_{2} {D}_{target} ( {η}_{v 1} , {η}_{v 2} , q ) ,$$
wherein J(v, \dot{v}, ηᵥ₂, q, \dot{q}, \ddot{q}) denotes an optimization function with respect to the desired trajectory v, \dot{v}, ηᵥ₁, ηᵥ₂, q, \dot{q}, \ddot{q}. ηᵥ₁ denotes a position vector of the underwater vehicle, D_{target}(ηᵥ₁, ηᵥ₂,q) denotes a distance between an end effector of the robotic arm and a target, κ₁ and κ₂ denote the weight coefficients to be designed.

9. A system for trajectory tracking control of a vehicle-manipulator coupling system with finite time prescribed performance, the system is applied to control a motion trajectory of the vehicle-manipulator coupling system, the vehicle-manipulator coupling system comprises an underwater vehicle and a robotic arm, and the system comprises:
a parameter obtain unit, configured to obtain a present motion state and a desired trajectory with a weakly coupling characteristic of the vehicle-manipulator coupling system, so as to calculate a difference between the present motion state and the desired trajectory to obtain a trajectory tracking error;
a performance function design unit, configured to design a finite time performance function to constrain the trajectory tracking error so that the vehicle-manipulator coupling system reaches a steady state in response to the trajectory tracking error converging to a preset convergence boundary; and a gradient of the finite time performance function is not zero in response to an operation time of the vehicle-manipulator coupling system exceeding a preset convergence time, so as to avoid generating a singularity in a calculation of the state of the vehicle-manipulator coupling system and to ensure that a controller of the vehicle-manipulator coupling system does not diverge;
an error transformation unit, configured to convert the trajectory tracking error to obtain a corresponding transformed error in a case that constraint conditions corresponding to the finite time performance function are satisfied;
a control input design unit, configured to design a sliding mode surface of the vehicle-manipulator coupling system based on the transformed error to control the transformed error to converge in a finite time, and observe an external disturbance of the vehicle-manipulator coupling system based on a non-linear disturbance observer and the sliding mode surface; and design a control input of the vehicle-manipulator coupling system based on the sliding mode surface and the external disturbance observer, so that the vehicle-manipulator coupling system is controlled to operate according to the desired trajectory; designing the control input of the vehicle-manipulator coupling system based on the sliding mode surface and the external disturbance observer specifically is:
$${τ}_{m} = {A}_{m}^{- 1} [ - {B}_{m} - {\hat{F}}_{dm} - {γ}^{- 1} ( {H}_{m} + {k}_{α} {‖ {s}_{m} ‖}^{\frac{1}{2}} sign ( {s}_{m} ) + {\int }_{0}^{t} {k}_{γ} sign ( {s}_{m} ( τ ) ) d τ ) ] ,$$
wherein
τₘ represents a control input, k_{α} and k_{γ} represent controller parameters to be designed, sign(·) represents a signum function, τ represents a time, sₘ(τ) represents a value of sₘ at the time τ, sₘ represents the sliding mode surface, ∫₀^{t}k_{γ}sign(sₘ(τ))dτ represents an integral of k_{γ}sign(sₘ) at a time interval [0, t]; Aₘ and Bₘ represent a matrix related to a dynamics model of the vehicle-manipulator coupling system; \hat{F}_{dm} represents observation of a unknown external disturbance;
$$γ = \frac{( {κ}_{u} + {κ}_{l} ) {ρ}_{m}}{2 ( {κ}_{l} {ρ}_{m} + {η}_{e} ) ( {κ}_{u} {ρ}_{m} - {η}_{e} )} ,$$
κₗ and κᵤ represent performance boundary coefficients, ηₑ represents the trajectory tracking error, ρₘ is an abbreviation of ρₘ(t), and ρₘ(t) represents a trajectory tracking error boundary; and
$${H}_{m} = ( {λ}_{m} γ + \dot{γ} ) ( {\dot{η}}_{e} - \frac{{η}_{e} {\dot{ρ}}_{m}}{{ρ}_{m}} ) - γ \cdot \frac{{\dot{η}}_{e} {\dot{ρ}}_{m} {ρ}_{m} + {η}_{e} {\ddot{ρ}}_{m} {ρ}_{m} - {η}_{e} {\dot{ρ}}_{m}^{2}}{{ρ}_{m}^{2}} - γ {\ddot{η}}_{d} ,$$
\dot{γ} represents a first order derivative of γ, \ddot{ρ}ₘ is an abbreviation of \ddot{ρ}ₘ(t) being a second order derivative of ρₘ(t), \ddot{η}_{d} represents a second order derivative of the desired trajectory η_{d}, \dot{η}ₑ represents a first order derivative of the trajectory tracking error ηₑ, λₘ represents a diagonal sliding mode surface coefficient matrix, and \dot{ρ}ₘ is an abbreviation of \dot{ρ}ₘ(t) being the first order derivative of ρₘ(t),
wherein the control input includes control signals of the underwater vehicle and control signals of the robotic arm,
the controller of the vehicle-manipulator coupling system is configured to:
generate corresponding control forces by driving thrusters of the underwater vehicle based on the control signals of the underwater vehicle, and command joint motors of the robotic arm to
output corresponding torques based on the control signals of the robotic arm, such that the robotic arm performs a grasping action after the underwater vehicle moves to a target position.
